(19) United States
(12) Patent Application Publication
(10) Pub. No.: US 2006/0279258 A1
(43) Pub. Date: Dec. 14, 2006

(54) Method and system for providing current leveling capability

(75) Inventors: Christopher C. Jung, Mission Viejo, CA (US); Amir H. Khashayar, Laguna Niguel, CA (US); Glenn Sussman, Laguna Nigel, CA (US)

Correspondence Address: ALCON, IP LEGAL, TB4-8, 6201 SOUTH FREEWAY, FORT WORTH, TX, 76134, US

(73) Assignee: ALCON, INC.

(21) Appl. No.: 11/147,686

(22) Filed: Jun. 8, 2005

(51) Int. Cl. H02J 7/00

(52) U.S. Cl. 320/166

(57) ABSTRACT

The present invention relates to systems and methods for leveling a power supply current into a circuit that drives a pulsed load, such as a surgical cataract handpiece. According to various embodiments for current leveling of the present invention, the input current is leveled to regulate power being drawn from a power supply to prevent supply current surges that can: a) warrant a higher-rated supply; b) cause large voltage dips on a supply that supports other devices; or c) both.

### BACKGROUND OF THE INVENTION

The present invention relates to the field of current leveling. More specifically, the present invention relates to methods and systems for leveling a current supply to a pulsed load, such as an apparatus for ophthalmic surgery, to achieve efficient power management.

There exist numerous power applications and devices that require high power pulses, i.e., high instantaneous power with a low duty cycle. One example of such power applications is in ophthalmic surgery, particularly, cataract surgery. Cataracts are typically described as clouding of the eyes, and cataracts are responsible for impairing the vision of many people worldwide. As old cells die, some of these dead cells accumulate within the capsule containing the lens of the eye. This accumulation of dead cells causes a clouding of the lens, i.e., a cataract. There are many techniques that are available to alleviate or treat cataracts. One technique entails using a power device in the form of a surgical handpiece to make an incision or otherwise breach the capsule of the lens. The old cells are then broken up and extracted using, for example, high energy and high velocity pulses of a warmed liquid solution. As such, a surgical handpiece used for cataract surgery may require short pulses of high level of power to provide the warmed liquid solution at such a high velocity. However, providing this high level of power in short bursts or pulses causes some concerns.

One main concern is the required use of large and heavy power supplies to meet load demands for high-level bursts of power. Without a large power supply to support such power demand from a system, current overloads can result, which in turn can cause quick and frequent system shutdowns. Consequently, the system can experience operational delays associated with system cool down and/or restart and would not be a viable or practical product. The system can further experience high operational costs associated with system downtime and maintenance. On the other hand, large power supplies can also be considerably more expensive to purchase.

A conventional technique for dealing with the aforementioned concern is shown in FIGS. 1-3. In FIG. 1, a power supply input 3 supplies a largely DC voltage from a supplied AC voltage source to an input module 5, which then levels the current from the power supply input 3 to regulate the build up in energy that is delivered to a transformer 7. The input module 5 and the transformer 7 are parts of the RF driver or pulse load generator for a load 9, which is a pulsed load that requires high-level bursts of power or is configured to store or bank energy/power for a specific or extended time period. As such, the pulsed load expects a specific instantaneous power to be supplied to it for a specific interval of time. An example of the load 9 is a surgical cataract handpiece 9a having two electrodes as shown in FIG. 1. The transformer 7 steps up the voltage from the input module 5 to generate a high voltage, i.e., a voltage many times larger than the voltage supplied to the transformer. The high voltage is then supplied to the load 9.

FIG. 2 depicts an exemplary detailed circuit configuration of the conventional system shown in FIG. 1. In FIG. 2, the AC input voltage 20, power supply 21, and capacitor 23 correspond to components in the power supply input 3 (FIG. 1); the inductor 25, the capacitor 121, and the transistors, i.e., switches, 27 and 29 correspond to components in the input module 5; the transformer 123 corresponds to the transformer 7 (FIG. 1); and the load 125 corresponds to the load 9 (FIG. 1). As shown in FIG. 2, the AC input voltage 20 is supplied to the power supply 21. The input voltage is, for example, 110 volts AC. The power supply 21 then converts the input voltage to a desired load voltage, e.g., 24 volts, and supplies a predetermined average current of, e.g., about 2 amperes (2 A). The power supply 21 is coupled to capacitors 23 and 121 and a center tap of a primary winding of transformer 123. Thus, the power supply charges the capacitors. It should be noted that capacitor 23 can be internal to and a part of the power supply 21.

The center tap of the transformer 123 separates the primary winding into two halves, an upper half and a lower half. It should be noted that other configurations for the transformer 123, e.g., a multi-tap primary winding, can be applied here as well. Coupled to one end of the upper half is the transistor 27; to one end of the lower half, the transistor 29. The upper and lower halves of the primary winding share the center tap. Both transistors 27 and 29 act as switches to permit or prevent current and voltage from being applied to the transformer 123. Thus, when transistor 27 is biased to turn on and transistor 29 is biased to turn off, current flows through the upper half of the transformer and voltage, e.g., 24 volts, is applied. Likewise, when transistor 29 is biased to turn on and transistor 27 is turned off, current flows through the lower half of the transformer and voltage is applied. However, the current and voltage applied are opposite in polarity to the current and voltage applied when transistor 27 is on and transistor 29 is off. Thus, following the sample voltage and current values given above, −24 volts is applied to the lower half of the transformer 123. When transistors 27 and 29 are both off, no current or voltage is experienced by the transformer 123. The transistors 27 and 29 are prevented from being both on at the same time.

The transformer 123 has a requisite turn ratio to step the voltage supplied to its primary winding to a level needed by the load 125. For example, the transformer 123 has a 1 to 6 (1:6) turn ratio in order to step up the 24 volts supplied to the upper half of the primary winding of the transformer 123 to about 150 volts at the output of the secondary winding of the transformer 123. Similarly, −24 volts provided to the lower half of the primary winding of the transformer 123 is stepped up to about −150 volts at the secondary winding of the transformer 123. The output voltage from the transformer 123 is then supplied to the load 125 coupled to the secondary winding. As mentioned earlier, the load 125 can be a surgical handpiece having two electrodes, whereby each electrode is coupled to one end of the secondary winding of the transformer 123 and utilizes the output voltage to heat liquid positioned between the electrodes.

Waveforms illustrated in FIG. 3 depict the voltage and current at the secondary winding of the transformer 123 versus time. Thus, as described above with reference to FIG. 2 and as shown in FIG. 3, a square waveform of voltage 31 and a square waveform of current 33 are produced. As such, a ±150-voltpeak voltage and an ±8 A peak current are generated at the secondary winding of the transformer 123. With the peak voltage about 150 volts and the peak current about 8 A, the instantaneous power is about 1,200 watts. As further shown in FIG. 3, the transformer provides a 2-millisecond (ms) burst of voltage and current and reduces to zero current and voltage and remains at zero for the remaining period, e.g., 48 ms until the next burst. Thus, the transformer is active for about 4% of the time and thus provides about 48 watts of average power (0.04*1,200).

As voltage is applied to the center tap of the transformer 123, the capacitors 23 and 121 quickly charge to the value of the applied voltage. When both transistors 27 and 29 are cycled as described above, capacitors 23 and 121 gradually discharge. Accordingly, as shown in FIG. 3, the peak voltage drops to about 135 volts as both capacitors 23 and 121 discharge. Please note FIG. 3 may not be drawn to scale. The peak current also drops due to the voltage drop across the secondary winding and as the load resistance increases due to, e.g., liquid boiling away in the surgical cataract handpiece 9a.

The output of the transformer 123 also reflects a current back from the secondary winding to the primary winding. As such, 48 A of current is experienced at the primary winding due to the 1:6 turn ratio of the transformer 123. Such a high current produces concern, including but not limited to, ground bounce due to resistance and/or inductance from printed circuit board (PCB) traces or components on the PCB, or potential damage to the power supply. As such, the capacitors 23 and 121 provide a path to ground to discharge or otherwise absorb the current instead of the current being experienced by the power supply 21. However, a voltage drop or dip would result in the power supply 21.

To minimize the above-mentioned voltage drop in the power supply, the capacitors 23 and 121 need to be sufficiently large. For instance, based on a one-volt voltage drop experienced by the power supply 21, the capacitors 23 and 121 should be 96,000 μF (surge current*burst time/one volt). The capacitors 23 and 121 deliver charge at a frequency of about 20 Hz, i.e., 2 ms (ms) in every 50 ms, or 100 Hz, i.e., 1 ms in every 10 ms, respectively.

Conventionally, an inductor 25 is provided and coupled to the capacitors 121 and 23, the power supply 21, and the transformer 123. The inductor 25 blocks the surge current from being experienced by the power supply 21, capacitor 23, and other components or connections between the power supply 21 and the transformer 123. Similar to the capacitor 121, the inductor 25 can be quite large. For instance, based on the following equations, for a 50 ms period and a capacitor 121 of 100,000 μF, the inductor is about 150 μH.

$$Period T = 1 / frequency = 2 π \sqrt{LC} ;$$

$$Inductance = \frac{1}{C} {( \frac{T}{2 π} )}^{2} = \frac{1}{100 \text{,} 000 μ F} {( \frac{25 ms}{2 π} )}^{2} .$$

The internal DC resistance of the inductor 25 may also result in a voltage drop. For instance, for an inductor with a resistance of 0.43% and a 2 A average current being supplied to the inductor, a voltage drop of 0.86 volts (V) would occur and thus 1.8 watts of power (0.86V*2 A) would be dissipated, which is about 4 percent of the total power. The current and voltage waveforms shown in FIG. 4 show the effect of the inductor 25 on the voltage and current experienced by the transformer 123 as described above. As such, voltage waveform 41 shows about one volt of voltage drop 41a, due to the inductor, that is experienced by the transformer. In addition to the one volt drop due to depletion of energy from the capacitors 23 and 121, current waveform 43 shows the current reflected back when the capacitor 121 is discharged and thus about 48 A of current occurs for about 2 ms. Current waveform 45 shows the input current provided by the power supply 21, with a ripple current peaking at about 5.7 A for about 25 ms, when capacitor 23 is charging. This ripple current may result in electromagnetic interference and affect the power supply. To additionally flatten the current from the power supply, i.e., reduce the ripple current, a larger inductor can be used. For example, a larger inductor can cause the current from the power supply 21 to exhibit less than 20% ripple current, or about 400 mA on an average of 2 A, and possibly reduce the EMI effects even further.

### SUMMARY OF THE INVENTION

There are several disadvantages associated with the conventional current-leveling system shown in FIGS. 1 and 2. For instance, while there may be relatively little cost associated with the use of the capacitor 121 having such a large value (e.g., 100,000 μF) in the system, such capacitor is large, and the inductor 25 is both large and heavy in size, and thus may not be practical for implementation. Further, the value of the capacitor 121 and inductor 25 are preset and rigid, thereby denying the conventional current-leveling system the flexibility to adapt to different power demands of the load.

The present invention advantageously addresses at least the needs for load current leveling and the above disadvantages in the conventional current-leveling scheme by providing a system and method for supplying and maintaining a more constant current level at the power supply load, providing flexibility in adjusting such current level per load demand, avoiding extreme fluctuation in the power supply load current due to predictable and repetitive load requirements, and thereby eliminating the need for large and expensive power supplies. Accordingly, in one embodiment of the present invention, there is provided a system with high-burst load requirements having an input module receiving an input voltage and current and leveling out the input current in conjunction with a recharge module and a voltage and/or current sensor circuit, a transformer coupled to the input module and configured to increase the voltage and current from the input module, and a load. The system also has an output module coupled to the transformer and the load to apply the increased voltage and current from the transformer along a first polarity of the load during a first portion of a cycle and apply the increased voltage and current from the transformer along an second polarity of the load during a second portion of the cycle, the second polarity being opposite in polarity to the first voltage.

In still another embodiment of the invention, a system with high-burst load requirements, such as a cataract surgical module, includes a pulsed load, a capacitor bank, an output driver and recharge circuitry. The capacitor bank is coupled to the pulsed load and is configured to store energy. The output driver is also coupled to the pulsed load and is configured to transfer energy to the pulsed load. The recharge circuitry is configured to receive and level an input current to regulate build up of the stored energy on the capacitor bank.

Many of the attendant features of this invention will be more readily appreciated as the same becomes better understood by reference to the following detailed description and considered in connection with the accompanying drawings.

### BRIEF DESCRIPTION OF THE DRAWINGS

The preferred embodiments are illustrated by way of example and not limited in the following figure(s), in which:

FIG. 1 illustrates a high-level block diagram of a conventional system for handling a high-power, pulsed load, such as a surgical cataract handpiece;

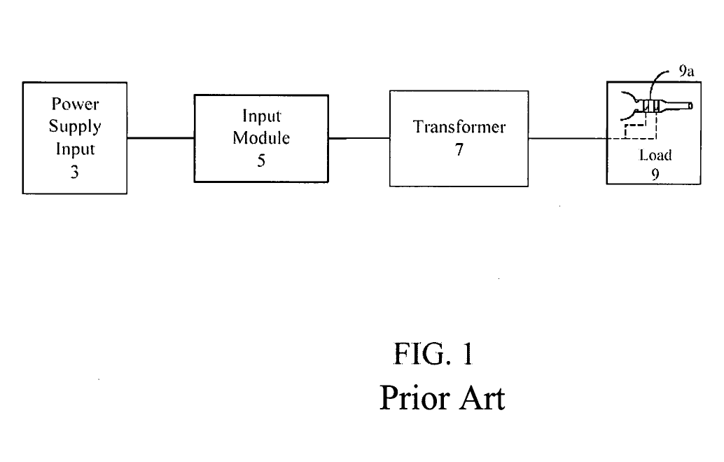

FIG. 2 illustrates a detailed schematic diagram of the conventional system shown in FIG. 1;

FIG. 3 illustrates waveform diagrams exemplifying voltage and current experienced at an output of the transformer shown in FIGS. 1 and 2;

FIG. 4 illustrates waveform diagrams exemplifying the effect of an inductor on the input voltage and current experienced by the transformer and the input power supply shown in FIGS. 1 and 2;

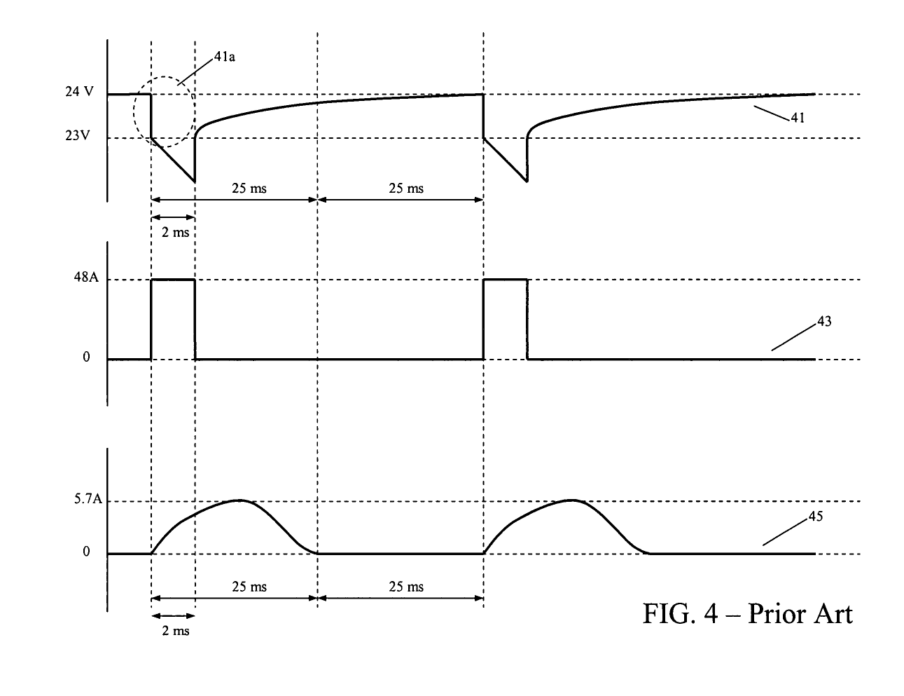

FIG. 5 illustrates a block diagram of a current-leveling system in accordance with another embodiment of the present invention;

FIG. 6 illustrates a detailed diagram exemplifying a circuit configuration of FIG. 5 in accordance with an embodiment of the present invention;

FIG. 7 illustrates waveform diagrams exemplifying the input voltage and current experienced by a transformer and the input power supply in a current-leveling system as shown in FIGS. 5 and 6, in accordance with an embodiment of the present invention;

FIG. 8 illustrates waveform diagrams exemplifying voltage and current, in relation to the operational period of a transistor, experienced by the transformer shown in FIGS. 5 and 6, in accordance with an embodiment of the present invention;

FIG. 9 illustrates waveform diagrams exemplifying current and voltage experienced by the transformer shown in FIGS. 5 and 6 in relation to an operational period of a transistor, in accordance with another embodiment of the present invention;

FIG. 10 illustrates waveform diagrams exemplifying current experienced at the input and output of a current leveling system shown in FIGS. 5 and 6, in accordance with an embodiment of the present invention;

FIG. 11 illustrates a detailed schematic diagram of a portion of the current leveling system that regulates the input current, in accordance with an embodiment of the present invention;

FIG. 12 illustrates a block diagram of a current leveling system, in accordance with another embodiment of the present invention;

FIG. 13 illustrates a detailed schematic diagram exemplifying a partial configuration of the current leveling system shown in FIG. 12a, in accordance with an embodiment of the present invention; and

FIG. 14 illustrates a detailed schematic diagram exemplifying another partial configuration of the current leveling system shown in FIG. 12, in accordance with an embodiment of the present invention.

### DETAILED DESCRIPTION OF THE INVENTION

Reference is now made in detail to embodiments of the present invention, an illustrative example of which is illustrated in the accompanying drawings, in which like numerals indicate like elements, showing methods and systems for leveling a current supply to a pulsed load, such as a cataract surgical handpiece.

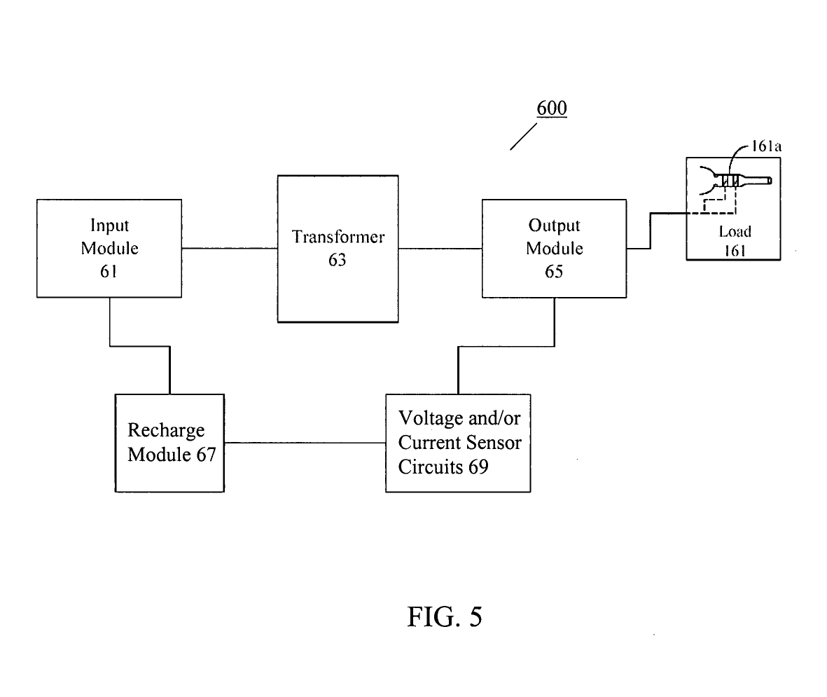

Referring to FIG. 5, according to one embodiment of the present invention, there is provided a current-leveling system 600 that has the flexibility to adjust and maintain a constant level of current supply to a system load 161 based on the demand of such load. Again, the load 161 is shown as a surgical cataract handpiece 161a for example. As shown in FIG. 5, an input module or circuit 61 is coupled to a transformer module or circuit 63. The input module 61 receives input power from a power supply (not shown) and filters the input power. In one embodiment, the input module 61 includes inductance and capacitance units used to filter the input power. It is also used to reduce changes in voltage experienced by the power supply as further described below. The filtered input power is then supplied to the transformer module 63. The transformer steps up the power voltage and supplies the power to an output module or circuit 65, which then filters the output power from the transformer module 63 and supplies the filtered output power to the load 161. The output module 65 is coupled to a voltage and/or current sensor module or circuit 69. The voltage and/or current sensor circuit 69 monitors the voltage and/or current in the output module 65 so that the system 600 can regulate power being supplied to the load 161 using a recharge module or circuit 67 coupled to the input module 61 to manipulate the filtered input power.

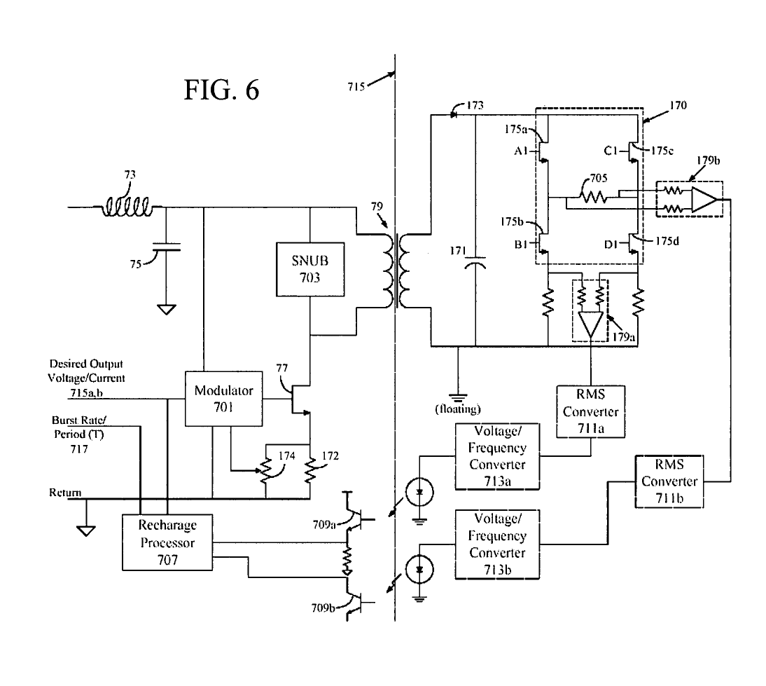

FIG. 6 depicts one example of a circuit configuration that can be used to implement the system shown in FIG. 5. Based on the present disclosure, it should be clear to one skilled in the art that other circuit configurations can be implemented as well to perform the functions described herein and still be within the scope of the present invention. As shown in FIG. 6, the inductor 73, capacitor 75, snub circuit 703, modulator 701, transistor 77, potentiometer 174, and resistor 172 correspond to components in the input module 61 in FIG. 5; the transformer 79 corresponds to a component in the transformer module 63 in FIG. 5; the recharge processor 707 corresponds to a component in the recharge module 67 in FIG. 5; transistors 709a and 709b correspond to components in the voltage and/or current sensor circuit 69 in FIG. 5; resistor 705 on the right side of the magnetic-isolated interface, i.e., dashed line, 715 represents the load 161 in FIG. 5; and all other elements on the right side of the magnetic-isolated interface 715 correspond to components in the output module 65 in FIG. 5. Again, the load 161 can be, for example, a surgical cataract handpiece. Alternative embodiments are contemplated wherein the aforementioned components in their respective modules/circuits can be parts of a different modules/circuits. For example, the modulator 701 can be a component in the recharge module 67, and the voltage and/or current sensor circuit 69 can be a component in the output module 65. FIG. 6 is further described below.

Starting with elements on the left side of the magnetic-isolated interface 715 in FIG. 6, an input voltage is supplied to the inductor 73. For example, the input voltage is 24V. The inductor 73 is coupled to the capacitor 75 and together act as a filter, as mentioned above, to reduce ripple components from the input voltage to provide a relatively flat DC current. As such, the inductor 73 and the capacitor 75 provide sufficient local current storage for the input current, e.g., a high frequency pulse current, and sufficient resistance to draw the input current from the power supply (not shown). One end of a primary winding of transformer 79 is coupled to the capacitor and the opposite end of the primary winding is coupled to a transistor 77. The transistor 77 is coupled to a modulator 701 which, in one embodiment, is a pulse width modulator.

The transistor 77 acts as a switch that is controlled by the modulator 701 providing input to the base of the transistor 77. When transistor 77 is turned on, a path to ground via resistor 172 and potentiometer 174 is established. As such, current flows through the primary winding of the transformer 79, and thus the filtered input voltage is applied to the transformer 79. A snub circuit 703 is coupled to the transistor 77 to limit the rate of the current rising through the transistor 77 when it is turned on and thus reduces EMI from such transistor and also absorbs stray energy that might otherwise damage the transistor 77.

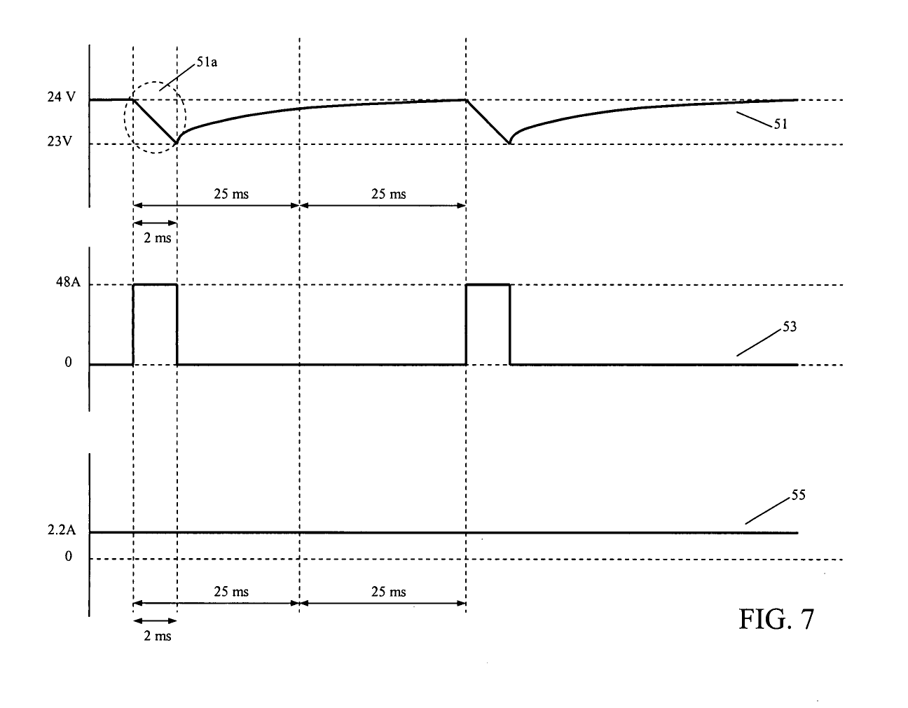

While transistor 77 is on, diode 173 prevents current from flowing through the secondary winding of the transformer 79. However, when transistor 77 is turned off, the diode is forward biased, resulting in a delayed or flyback current flow through the secondary winding of the transformer 79 and to the capacitor 171 and the H-bridge 170. The current flowing to the capacitor 171 charges the capacitor 171. Thus, voltage from the primary winding is transferred to the secondary winding of the transformer, the output of the transformer, when transistor 77 is turned off. The current from the secondary winding is a fraction of the current through the primary winding. In other words, the current through the secondary winding is 1/n of the current through the primary winding, where n is the number of turns of the secondary winding. Likewise, the voltage at the secondary winding is larger, i.e., n times greater, than the voltage at the primary winding. FIG. 7 shows a single capacitor 171; however, it should be understood that a capacitor bank having one or more capacitors connected in series or parallel can also be employed in place of the capacitor 171.

Thus, the transformer 79 steps up the input voltage to provide a larger voltage to the H-bridge 170 and the storage capacitor 171. The H-bridge includes transistors 175a-d and is coupled to a load 705. Each of the transistors 175a-d is controlled by an input, i.e., control inputs A1, B1, C1, D1, provided to the base of each transistor. In one embodiment, such control inputs can be provided by the recharge module 67, e.g., by the recharge processor 707.

The control inputs A1, B1, C1, and D1 are grouped or provided so that a pair of transistors, i.e., transistors 175a and 175d, are turned on, when the other transistor pair, i.e., transistors 175b and 175c, are off and vice versa. In addition, the inputs provided to each transistor are provided so that transistors 175a and 175b are not turned on at the same time and that transistors 175c and 175d are not turned on at the same time. In one embodiment, the transistors are selected as having a thirty-amp (30 A) rating when an eight-amp (8 A) current is expected to prevent potential damage to the devices should a large current pulse occur.

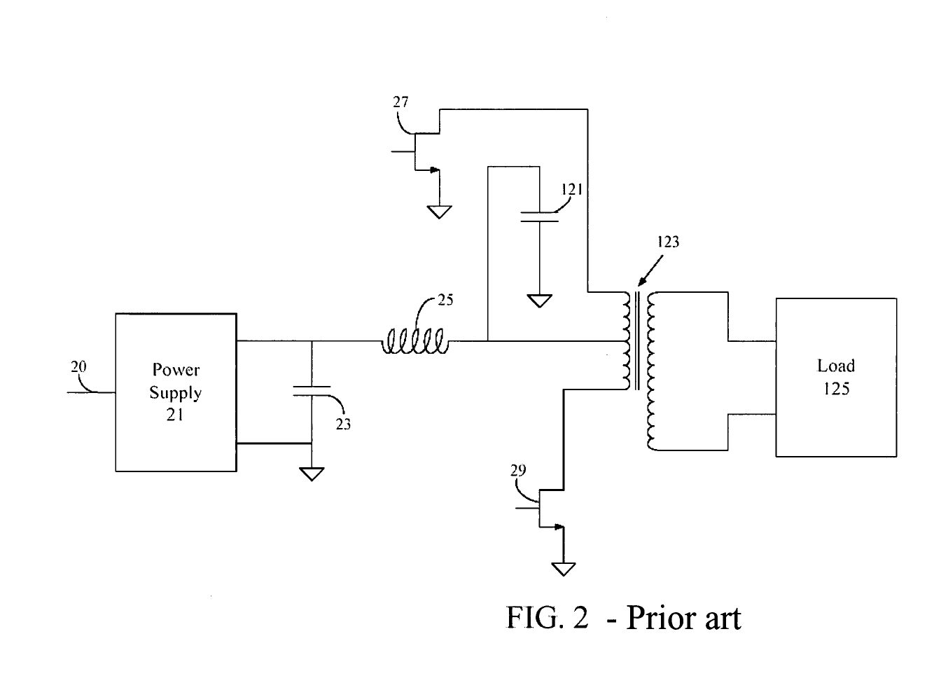

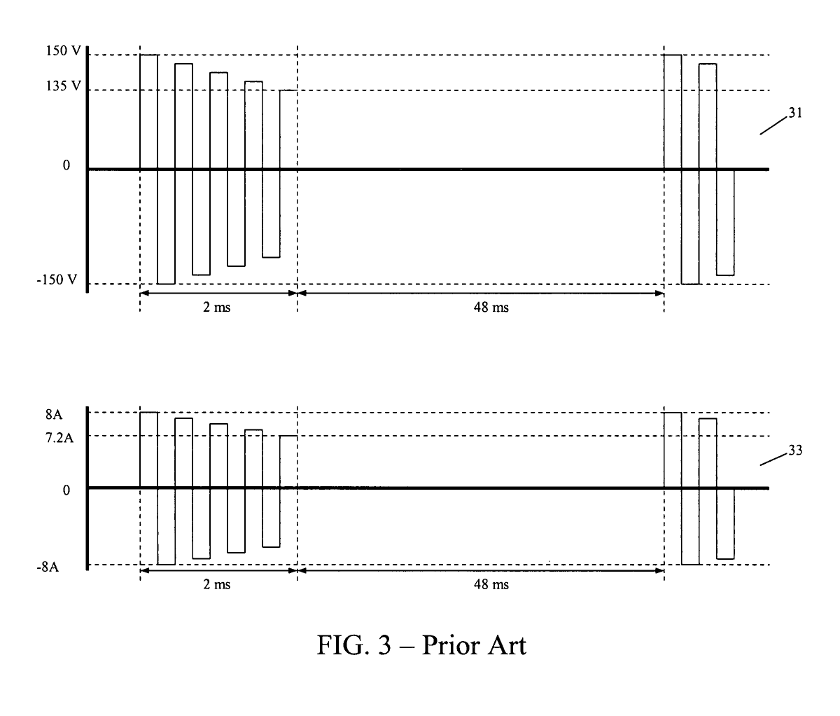

When transistors 175a and 175d turn on and transistors 175b and 175c turn off, current flows through the load 705 and voltage from the transformer 79 is applied to the load 705. Likewise, when transistors 175a and 175d turn off and transistors 175b and 175c turn on, current flows through the load 705 and voltage from the transformer 79 is applied to the load 705. Therefore, the voltage and current experienced at the load 705 is similar to the voltage and current described in reference to FIG. 2, through control of the transistor switches 27 and 29, and shown in FIG. 3. However, a sharper edge on the waveforms may be present due to the H-bridge 170 connection to the load 705 instead of a roll-off at higher frequency due to the transformer 123 in FIG. 2.

The voltage across the capacitor 171 and the current to the H-bridge 170 track the envelopes of the voltage and current experienced at the load 705. In one embodiment, the current applied to the load 705 is tracked or sensed. As such, amplifier unit 179a is coupled to the H-bridge to provide the current or a sampling of the current to a first converter 711a that converts or determines the root means square value of the current. The first converter 711a provides the converted current to a second converter 713a that converts the current to a frequency for transmission across an magnetic-isolated interface 715.

Additionally or alternatively, in one embodiment, the voltage applied to the load 705 is tracked or sensed. As such, amplifier unit 179b is coupled to the H-bridge to provide the voltage or a sampling of the voltage to a third converter 711b that converts or determines the root means square value of the voltage. The third converter 711b provides the converted voltage to a fourth converter 713b that converts the voltage to a frequency for transmission across the magnetic-isolated interface 705 to the recharge processor 707 (connections not shown). In another embodiment, the voltage across the capacitor 171 is sensed or checked to track the voltage across the load 705. As such, the voltage across the capacitor can be converted to a frequency or a pulse width and transmitted across the interface 715.

Outputs from the second converter 713a and fourth converter 713b are detected and/or converted to voltage by transistors 709a and 709b. These transistors are coupled to the recharge processor 707. The recharge processor 707 compares predetermined limits for the current, as received from input 715b, and voltage, as received from input 715a, to be applied to the load 705 to the detected current and voltage represented by the respective voltages provided by the transistors 709a,b. Based on the comparison, the recharge processor 707 notifies, e.g., sends an error signal, to the modulator 701. From the error signal and the desired voltage and current inputs 715a-b, the modulator 701 adjusts the input to transistor 77 to make the detected current and/or voltage correspond to the predetermined limits or to reduce the error signal to zero. The error signal, in one embodiment, provides a difference value between the current/voltage detected and the current/voltage limit. As shown in FIGS. 5 and 6, amplifiers 179a-b and converters 711a-b, 713a-b can be parts of either the output module 65 or the voltage and/or current sensor circuits 69 shown in FIG. 5.

In the aforementioned embodiment wherein the voltage across the capacitor 171 is sensed, a feedback signal based on the voltage across the capacitor 171 is provided to the modulator 701. Based on the feedback signal, the modulator is able to determine a difference between a desired voltage value and the actual voltage value sensed across the capacitor 171, i.e., at the secondary winding of the transformer 79. As such, the modulator 701, in one embodiment, adjusts an output pulse or control input to the transistor 77 so that the desired voltage value corresponds to the actual voltage value across the capacitor 171 or that the feedback signal indicates that the desired voltage value corresponds to the actual voltage value. In one embodiment, the frequency at which the transistor 77 turns on remains fixed, as determined by the recharge processor 707 based on the burst rate input 717. However, the pulse width of the output pulse is adjusted to vary the on-time duration of the transistor 77 to increase or decrease proportionally the current through the transistor 77 in order to cause the actual voltage value to correspond to the desired voltage value.

The resistor 172 limits the rate of power transfer through the transformer 79 by effecting the current through the transistor 77, such that the modulator 701 turns the transistor 77 off when a current limit is reached. In one embodiment, the current limit is predetermined. In another embodiment, a voltage limit is set and the modulator turns the transistor 77 off when a voltage limit is reached. In either embodiment, the switching frequency is fixed, such as at 100 KHz. The resistor 172 without the potentiometer 174 provides a current-sense voltage that varies from near zero, when at low output power and when the actual voltage value corresponds to the desired voltage value, to a near maximum limit, e.g., 1 volt, at full power or when modulation regulation is lost, e.g., when actual setup of the inductor due to the output power exceeds a preset limit.

FIG. 7 depicts the current and voltage waveforms as experienced by the transformer 79, as controlled by the input module 61, from the effect of the current leveling scheme shown in FIGS. 5 and 6. Voltage waveform 51 is similar to voltage waveform 41 showing the one volt voltage drop 51a caused by the depletion of energy in the capacitor 171; however, there is no longer the additional one-volt drop due to the inductor 73 because this is not a factor in the current leveling schemes of the present invention (i.e., the big surge current is kept to the capacitor 171 and not directly reflected into the inductor 73). Likewise, current waveform 53 is similar to the current waveform 43 showing the current reflected back when the capacitor 171 discharges. Current waveform 55 represents the input current, as controlled by the input module 61, and is flattened or leveled to a value of 1.8 A-2.2 A for the same voltage provided from the power supply. The areas for the discharge and charge waveforms are about equal.

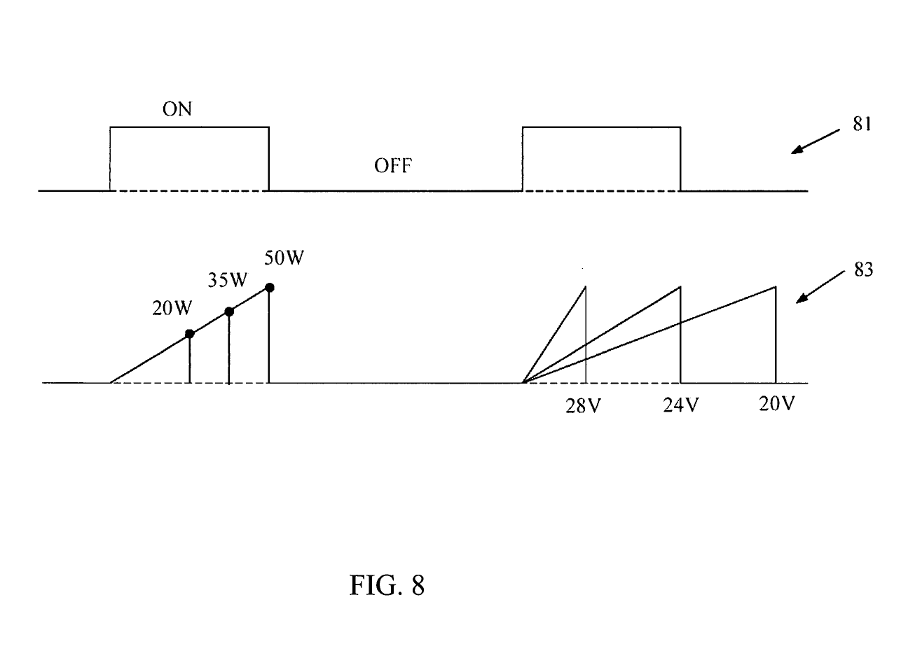

As illustrated in FIG. 8, the period 81 in which transistor 77 turns on and off is constant and for any given power level (e.g., 20W, 35W, and 50W are shown) the point at which transistor 77 turns off is the same. The waveform shape of the sense voltage, which represents the voltage across the resistor 172 and the current through the primary winding, is also the same for any load and input voltage, as shown in the voltage waveform 83. However, the slope of the current waveform varies with input voltage as needed to achieve a particular current, and thus energy level, based on the following equation:

$$\frac{1}{2} {LI}^{2}$$

For example, power of about 1200 watts (150V×8 A) is delivered for about 2 ms at an approximately constant rate. With each burst of power, a proportional dip in energy level of the capacitor 171 occurs according to the following formula:

$$Δ {E}_{c} = {\int }_{0}^{T} P ( t ) ⅆ t = \frac{1}{2} C ( {V}_{i}^{2} - {V}_{f}^{2} )$$

wherein P is the instantaneous power to the load, T is the duration of the burst, Vᵢ is the initial voltage on the capacitor 171 and V_{f} is the final voltage on the capacitor 171 after the burst. Also, as provided in the following formula, based on the exemplified values, the minimum capacitance of the capacitor 171 is 1,150 μF:
C=2PΔT/(V₁²−V_{f}²)=2(1200W)(2ms)/(150²-135²)

As such, the capacitance of capacitor 171 is much lower then the capacitance of the corresponding prior art capacitor 121 shown in FIG. 2. In one embodiment, the capacitor is rated at 1200 μF. The ripple current is limited to 3.5 A at 120 Hz and with a narrow width and a low duty cycle of 8 A per 2 ms each 50 ms. In another embodiment, the capacitor is rated at 3300 μF. With such capacitor value, the dip in voltage, i.e., the final voltage on the capacitor after the burst of power would be about 145V. The following calculation exemplifies the result.

$${V}_{f} = \sqrt{{V}_{i}^{2} - \frac{2 P Δ T}{C}} = \sqrt{{( 150 V )}^{2} - \frac{( 2 ) ( 1200 w ) ( 2 ms )}{3300 μ F}} = 145 V$$

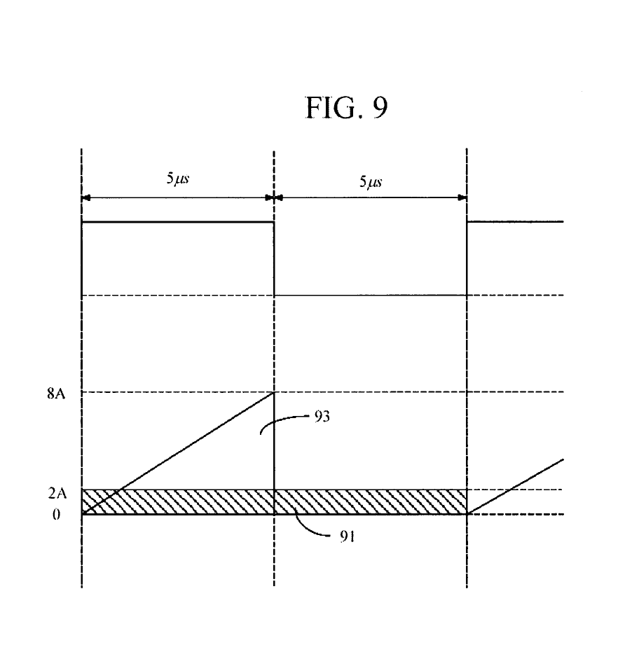

In another embodiment, the capacitor 171 having a 1,200 μF capacitance is provided a fixed maximum constant-current rate of current to replenish the charge on the capacitor by the next successive power pulse. For instance, with 15V lost (150V-135V) on capacitor 171 due to a drain of 1200 watts for 2 ms by the load 705, such energy is recoverable by adding or providing the lost energy over the idle or 48 ms period between pulses at a rate of 50 mill Joules/ms (i.e., 50 watts). With the input voltage being 24V, an average input current of 2.08 A (50 watts divided by 24V), would provide sufficient current to recharge the capacitor 171. During the 2 ms pulse, the energy transfer to the capacitor 171 also occurs with an average current of 2 A and a power rate of 48 watts. Thus, the peak instantaneous value of the current is about 8 A with the modulator 701 running at a 50 percent duty cycle at a maximum power level of 50 watts. As such, equal areas 91 and 93 in FIG. 9 represent the energy or power provided to the transformer 79. The sense voltage, i.e., the voltage across the resistor 172, coincides with the 8 A peaks and thus with the maximum sense voltage of about 1 volt, the resistance of resistor 172 is about 125 mΩ.

At a recharge rate of 2 A provided by resistor 172, the capacitor 171 recharges in time for the next power burst. However, if the next power burst provides a lower energy dissipation due to a slightly higher load resistance, for example, then the capacitor 171 will recharge sooner. Accordingly, the 2 A current limit provided by, for example, the transistor 77 and modulator 701, will stop as capacitor 171 reaches 150V.

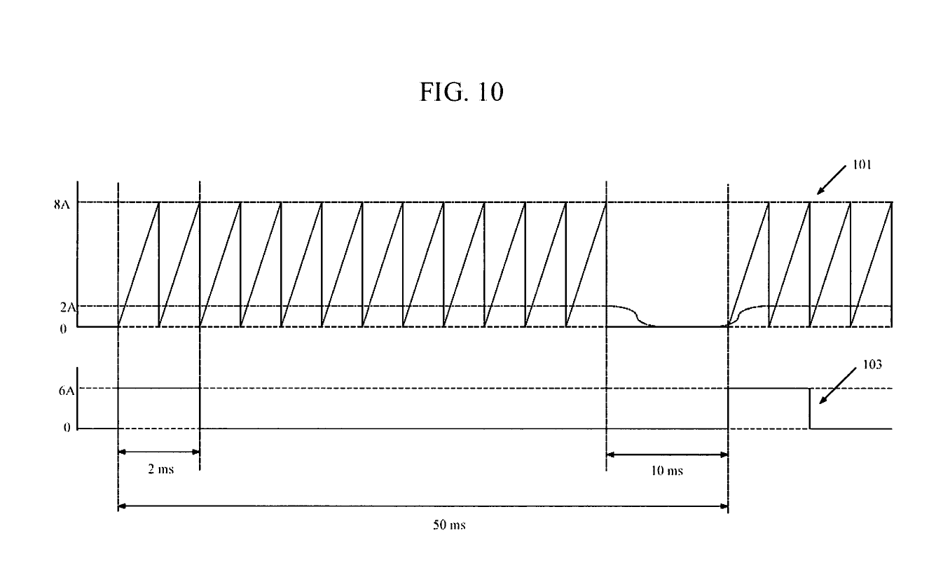

As shown in FIG. 10, a current waveform 101 representing the input current and the current waveform 103 representing the output current from the capacitor 171 show that the inductor 73, capacitor 75, and transformer 79 filter the input current when the modulator is operating at a frequency of 100 kHz. However, the combination of a fixed maximum current limit (i.e., 8 A peak or 2 A average as shown in the current waveform 101) and less than maximum power drawn by the load 705 results in the recharge of the capacitor 171 in a particular time interval sooner than is actually needed to prepare for the next pulse, which in turn results in an interval in which the average input current 101 can fall to zero. In one embodiment, such as that shown in FIG. 10, the modulator tends to run fully on or fully off. In contrast, the throttling of the modulator 701 sets a less than full on current limit of the current through the transformer 79 to allow the capacitor 171 to charge in a specific time frame, such that the capacitor voltage is restored just in time for the next pulse without a zero current interval, as seen in the waveform 55 depicted in FIG. 7.

In one embodiment, a programmable potentiometer 174, sets and adjusts the current limit for the modulator 701. Additionally, based on a feedback regarding the voltage across the load 705 or the capacitor 171, as previously described, the desired or predetermined voltage and the time available between output pulses in which to replenish the energy consumed by the output power pulse, the recharge processor 707 is able to set and adjust the current limit for the modulator 701. In one embodiment, the recharge processor 707 can be a dedicated processor, micro-controller or digital signal processor sharing resources with a resident processor. In another embodiment, the recharge processor 707 can be comprised of discrete analog and/or digital circuitry.

The recharge processor 707 scales the input current feedback using the potentiometer 174 to set a constant recharge rate for each output pulse cycle. The response time of the potentiometer 174, in one embodiment, is about 10 μs.

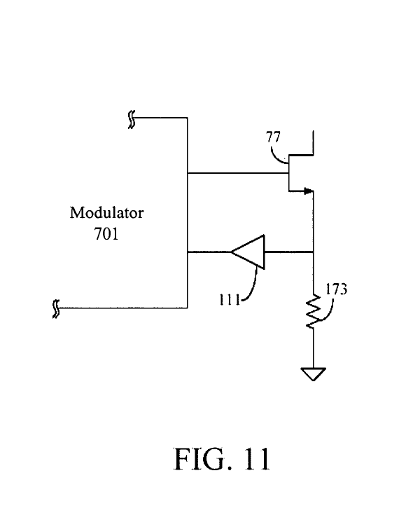

A programmable operational amplifier, however, also provides gain to the resistor 172 sense feedback voltage. As such, the resistor 172 is selected, in one embodiment, to not dissipate too much power and to develop a reasonable signal level at maximum current. The amplifier provides gain at lower currents to provide the peak input current, i.e., 1 volt sense voltage. Thus, a large resistor yielding a 1 volt sense voltage at a lower current, e.g., a quarter of the maximum current, such as 0.5 A, and then attenuating the voltage would not be needed. Average input current of 0.5 to 2 A is sufficient, and currents below 0.5 A may not matter considering the background current from other components may dominate anyway. FIG. 11 illustrates this embodiment of an amplifier 111 adjusting the input current.

The amplifier 111 is programmed to provide a constant one volt voltage feedback to the modulator 701 to signify or identify that the current through transistor 77 and thus the input current and voltage to transformer 79 has reached predetermined current and/or voltage limits. Additionally, the resistance of resistor 172 can be small and thus power dissipation would be low. For instance, a 2 A current through transistor 77 would cause a 0.2 volt voltage across resistor 172 having a resistance of 0.1Ω. As such, the amplifier would be programmed to provide a gain of 5 to provide a one volt voltage feedback. Likewise, an 8 A current through transistor 77 would cause a 0.8 volt voltage across resistor 172 and thus the amplifier would be programmed to provide a gain of 1.25 to again provide a one volt voltage feedback.

If filtering is desired of the zero input current interval, as shown in the current waveform 101 of FIG. 10 and a recharge processor is not used or desired, then the inductance of inductor 73 and the capacitance of capacitor 75 are increased and the resistor 172 is fixed to accommodate the maximum input current at all pulse widths, repetition rates and output voltages. The capacitor 75 takes on a value so that a dip of only 1 volt occurs and covers for a portion of the total pulse energy. In this embodiment, discharging of the capacitor 75 occurs, over 20 to 30 ms, instead of in 2 ms, as the modulator 701 replenishes the energy of capacitor 171. During the slower energy draw from capacitor 75, the input voltage would provide a portion of the energy so that the capacitor is smaller, e.g., less then 100,000 μF or about 22,000 μF.

Thus, the demands on filtering the non-DC component of the input current by the inductor 73 is eased by 80 percent effectiveness of the fixed feedback resistor 172 to expand the input current duty cycle. The capacitor 171 and the low duty cycle in the absence of the modulator energy transfer stage also addresses any high current concerns. However, the leveling or flattening of the input current is somewhat dependent on the dynamic range of the modulator 701, the maximum output pulse duty cycle, the dynamic range of the current sense feedback attenuator/amplifier, and/or the presence of noise.

In one embodiment, the values of inductor 73 and the capacitor 75 can be determined empirically to provide an acceptable input ripple and power loss over a full range of potential output voltages, frequency and pulse width, the response time requirements in tracking a desired output set point changes, and maintenance of the output voltage amplitude against various loads.

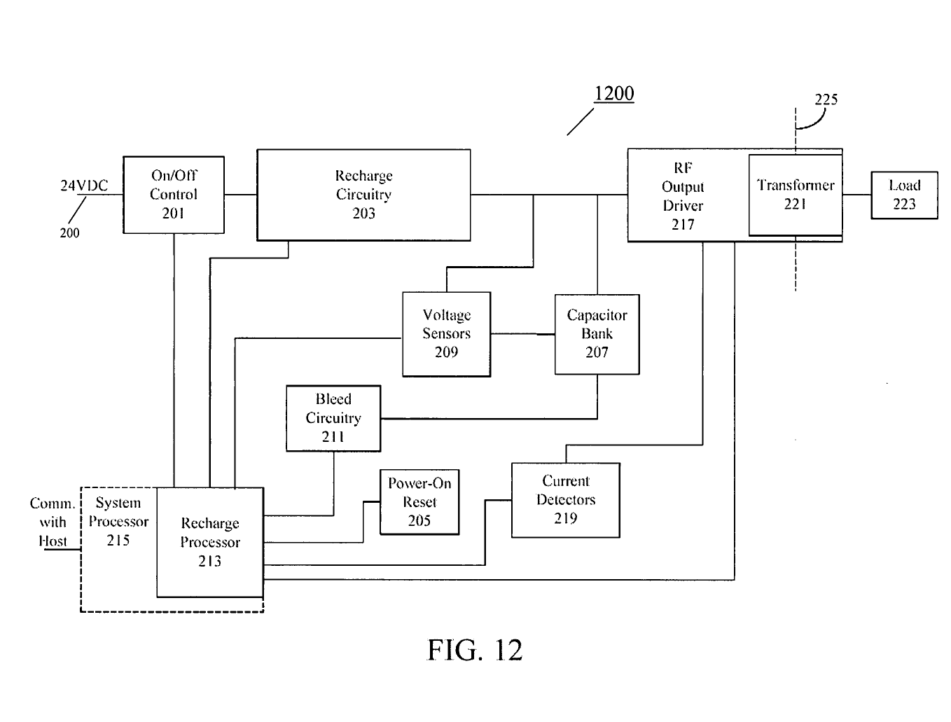

Referring to FIG. 12, there is provided a current-leveling system 1200 in accordance with another embodiment of the present invention. In FIG. 12, a power supply input 200 supplies a largely DC voltage from a supplied AC voltage source to an on/off control module 201. The on/off control module 201 receives a control input from a recharge processor 213. The recharge processor 213, in one embodiment, is a system processor 215 with a portion configured to handle recharge processing. The system processor 215 communicates with and performs instructions provided by a host controller (not shown). In one embodiment, the host controller is a computer configured with a user interface with which a system operator can configure and issue commands to the system processor 215, or receive, or view information provided by the system processor 215.

The received control input from the recharge processor 213 causes the on/off control module 201 to prevent or pass the DC voltage to a recharge circuitry 203. The recharge circuitry 203, in one embodiment, increases the DC voltage which is supplied to a capacitor bank 207 and a RF output driver 217. The capacitor bank 207 functions similarly to the capacitor 121 shown in FIG. 2. Likewise, the RF output driver 217 functions similarly to the circuitry exemplified by transistors 27 and 29 also shown in FIG. 2 or the H-bridge 170 shown in FIG. 6 and thus will not be further described here. Voltage sensors 209 are coupled to the recharge circuitry 203 to identify the amount of voltage being supplied to the RF output driver 217 and capacitor bank 207 and conveys this information to the recharge processor 213. The recharge circuitry 203 also regulates the current supplied to the capacitor bank 207. In particular, the recharge circuitry 203 levels the current that results, which is associated with the supplied DC voltage 200. A bleed circuitry 211 is coupled to the capacitor bank 207 to assist the recharge processor 213 in measuring the capacitance of the capacitor bank 207, which may vary, and to discharge the voltage stored in the capacitor bank 207.

The RF output driver 217 supplies the DC voltage to a transformer 221, which then transfers the voltage to a load 223 that expects a periodic pulse of energy. The transformer 221 may or may not be a part of the RF output driver 217, as desired. Again, for example, the load 223 can be a surgical cataract handpiece, wand or pen. Current detectors 219 are coupled to the RF output driver 217. The current detectors 219 identify faults and/or monitor operating conditions and provide this information to the recharge processor 213. Based on such information, the recharge processor 213, which is coupled to the RF output driver 217, regulates the current and voltage being supplied by the RF output driver 217 to the load 223.

A power-on reset module 205, in one embodiment, is coupled to the recharge processor 213. The power-on reset module 205 supplies a power on reset signal to the recharge processor 213 to effectively shutdown the recharge circuitry 203. In particular, the power-on reset module 205 causes the recharge processor 213 to signal the on/off control module 201 to prevent power from being supplied by the on/off control module 201 and to discharge the energy in the capacitor bank 207 via the bleed circuitry 211. The power-on reset module 205, in one embodiment, supplies the power-on reset signal based on input from the voltage sensors 209 and/or current detectors 219 indicating a fault or an operational problem with the RF output driver 217 or recharge circuitry 203.

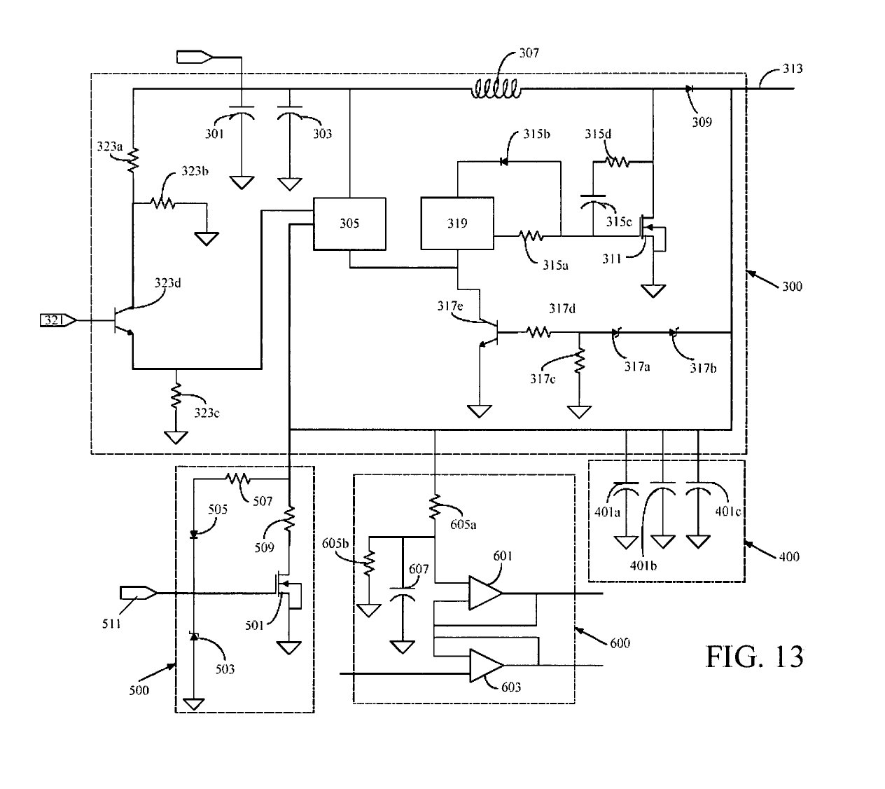

FIG. 13 illustrates exemplary embodiments of a recharge circuitry 300 (203 in FIG. 12), capacitor bank 400 (207 in FIG. 12), bleed circuitry 500, (211 in FIG. 12), and voltage sensors 600 (209 in FIG. 12) of the invention. The recharge circuitry 300 receives a current from the on/off control module 201 (FIG. 12). The current is from a generally DC voltage source and, in one embodiment, ranges from about 0 to 2.5 A, for example. The current is filtered by capacitors 301 and 303. The filtered current is monitored by a controller 305 and is supplied to a step-up inductor 307. The inductor 307 is coupled to a blocking diode 309 and a transistor 311. The transistor 311 controls the build up of charge on the inductor 307. As such, when the transistor is active, charge is allowed to build up on the inductor 307. When the transistor 311 becomes inactive, the built-up charge is released by the inductor 307 and forward biases the diode 309. Thus, a large voltage of about 150V, in one embodiment, is experienced at an output 313 of the recharge circuitry. The large voltage is also provided to a capacitor bank 400.

The transistor 311 is coupled to a capacitor 315c, resistors 315a,d and a diode 315b and a controller 319. The controller 319 receives a pulse signal and via such capacitor, resistors and diode affect the turn on and off times of the transistor switch 311. Thus, the rate at which the energy from the inductor 307 is released and stored is effectively controlled by those elements along with the transistor 311. By regulating the rate of build up and release of energy, electromagnetic interference can be reduced.

The recharge circuitry 300 receives a recharge current signal 321 from, for example, a recharge processor 213 (FIG. 12). The signal 321 can be conveyed using, for example, a pulsed photodiode or via digital to analog circuitry. The recharge current signal 321 is indicative of the maximum input current that is to be drawn in replenishing charge into the capacitor bank 400, and thus in restoring the recharge circuitry output voltage 313 to nominal. The recharge circuitry 300, and specifically the controller 305, uses a voltage to specify an amount of such source current. In particular, the recharge current signal 321 is converted to a voltage via resistors 323a,b,c and transistor 323d that is conveyed to the controller 305 which also conveys the rate to a second controller 319. The controllers 305 and 319 respectively supplement or effect the rate in which the input current is supplied to the step-up inductor and supplied from the step-up inductor 307 to the capacitor bank 400.

In one embodiment, the recharge circuitry 300 includes an over-voltage protection circuit. The over-voltage protection circuit includes a series of zener diodes 317a,b, resistors 317c,d and a transistor 317e. The zener diodes are situated and rated, such that voltage experienced at the capacitor bank 400 is recognized by the diodes. As such, if the voltage exceeds a predetermined voltage, such as 160V, a voltage is experienced across resistor 317c. Thus, transistor 317e turns on and pulls the signal provided by a controller 305 to controller 319 to ground. Hence, the transistor 317e effectively causes the controller 319 to not activate the transistor 311, to prevent energy from being transferred from the step-up inductor 307 to the load 223 via the transformer 221.

The capacitor bank 400 includes three capacitors 401a-c in parallel with each other. In one embodiment, the capacitors are 220 μF capacitors. The total number and rating of the capacitors may be more or less than described, depending on values of the other components and load demand in the system 1200, as understood by one skilled in the art based on the present disclosure. The capacitors 401a-c store the energy or a portion of the energy from the inductor 307, such that a voltage pulse can be provided when required or expected by the load 223, as indicated by a recharge processor 213 (FIG. 12) without a large increase or burst in current as reflected to the supply input 200 (FIG. 12). As a result, a level current can be maintained. Accordingly, the capacitor bank 400 holds or stores energy for the next RF burst for the load 223 to provide a constant current energy transfer.

Voltage sensors 600 are coupled to the capacitor bank 400 to identify the voltage experienced at the capacitor bank 400. The voltage sensors 600 include a series of resistors 605a,b and a capacitor 607 coupled to a first voltage amplifier 601. The first amplifier 601 provides a coarse scale for sensing the voltage. In particular, the first amplifier 601 identifies the voltage being supplied to the capacitor bank 400. For example, the first amplifier 601 determines if a zero or very minimal voltage is being experienced by the capacitor bank, and thus indicating that the system is off. Alternatively, the amplifier 601 determines if the voltage is being experienced by the capacitor bank 400, such as 150V, and thus the system is on or operating.

Another amplifier 603 provides a fine scale for sensing the voltage. Specifically, the second amplifier 603 determines the voltage experienced at the capacitor bank to a finer degree then the first amplifier 601. Thus, the second amplifier 603 senses the voltage experienced by the capacitor bank under normal operating conditions.

In one embodiment, the bleed circuitry 500 receives a bleed current indicator 511 from, for example, a recharge processor 213 (FIG. 12). The bleed current signal 511 specifies or identifies for the bleed circuitry an amount of current that should be reduced over a particular amount of time. In particular, the bleed current signal 511 is converted to a voltage and supplied to a gate of a transistor 501, via resistor 507 and diodes 503 and 505, to effect the transistor coupled to the capacitor bank. As such, the transistor 501 is manipulated to provide a path to ground to reduce or effect the rate of the current from the capacitor bank 400 through the discharge resistor 509 and thus to effectively discharge the capacitor bank 400 or reduce the voltage stored in the capacitor bank 400. The bleed current signal 511, in one embodiment, is conveyed through an magnetic-isolation interface 225 using for example a pulsed photodiode or via digital to analog circuitry.

The bleed circuitry 500 in conjunction with the recharge processor 213 also can be used to determine the capacitance of the capacitor bank 400. As noted above, the bleed circuitry controls or regulates the discharge of energy in the capacitor bank by removing or bleeding current from the capacitor bank 400. The amount of current removed is determined and monitored by the recharge processor 213. The recharge processor 213, based on the change in voltage and current from the capacitor bank 400, is able to determine the capacitance of the capacitor bank 400. Specifically, in one aspect, the following formula is used:
C=IΔT/ΔV
For example, using a one second time period and a change in voltage from 150V to 120V, i.e., a 30V dip, and a discharge current of 20 mA, the capacitance of the capacitor is calculated by the recharge processor to be about 660 μF. As such, the capacitor bank is charged to about 150V and then discharged by the bleed circuitry using a predetermined discharge current to a predetermined voltage.

By determining the capacitance of the capacitor bank 400, the recharge processor 213 is able to regulate the recharge current of the recharge circuitry 203. Specifically, in one aspect, the following formula is used:
I=CΔV/ΔT
Thus, the recharge circuitry is able to supply ample recharge current to ensure that sufficient voltage is experienced at the capacitor bank for supplying to the load at the appropriate time. Similarly, by determining the capacitance of the capacitor bank, the bleed circuitry is able to regulate the discharge current. As such, the bleed circuitry is able to remove current from the capacitor bank to ensure that sufficient voltage is experienced at the capacitor bank for supplying to the load at the appropriate time.

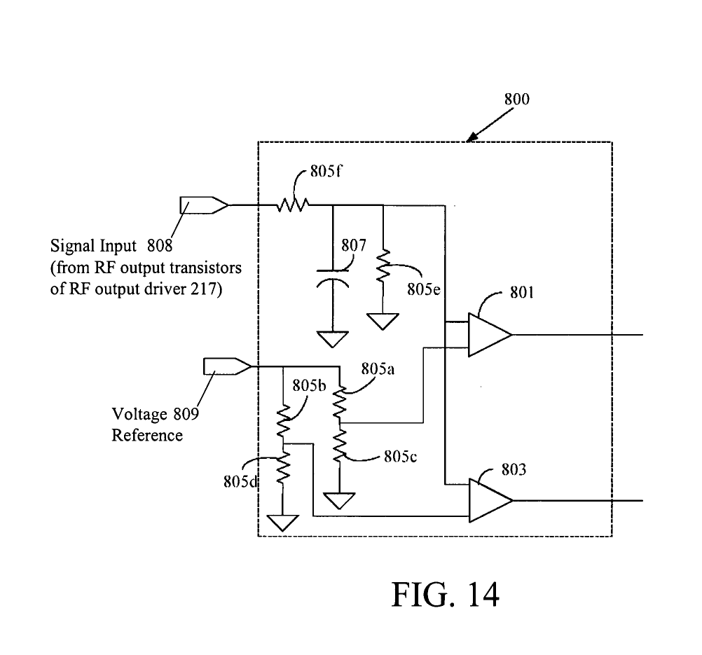

In FIG. 14, one embodiment of the current detectors 800 (219 in FIG. 12) is illustrated. The current detectors 800 are coupled to the switching transistors in the RF output driver 217 to receive a signal input 808 in order to identify the current experienced at those transistors. The current sensors 800 include a voltage reference 809 that is scaled by a series of resistors 805a-f and capacitor 807 that are coupled to two voltage comparators 801 and 803. The first comparator 801 senses the current under normal operation of the RF output driver 217 and the second comparator 803 senses the current in a fault condition. Specifically, the resistors 805a-f coupled to the first and second comparators 801 and 803 convert the sensed RF output driver current into a filtered voltage, and then compares this voltage to two reference levels to form the resultant signal that is produced by each comparator.

In one embodiment, the first comparator 801 provides a resultant signal to signify more than 8 A is being sourced by the RF output driver 217, and so it is operating under normal parameters. In one aspect, the first comparator provides a resultant signal to signify that less than 2 A of current is being sourced by the RF output driver 217, and so the output pulse from the RF output driver 217 is near the end. This signal is provided to the recharge processor to identify that the pulse has ended to provide feedback for closed-loop termination. In one embodiment, the second comparator provides a resultant signal to signify more than 20 A of current is being sourced by the RF output driver 217, or that a fault or a short-circuit has occurred in the RF output driver. This signal is supplied to the recharge processor to enable the recharge processor to shut down the RF output driver, in a manner previously described.

Although the invention has been described with reference to these preferred embodiments, other embodiments could be made by those in the art to achieve the same or similar results. Variations and modifications of the present invention will be apparent to one skilled in the art based on this disclosure, and the present invention encompasses all such modifications and equivalents.

We claim:

1. A system comprising:
a) pulsed load;
b) a capacitor bank coupled to the pulsed load to store energy;
c) an output driver coupled to the pulsed load and configured to transfer energy to the pulsed load; and
d) a recharge circuitry configured to receive and level an input current to regulate build-up of the stored energy in the capacitor bank.

2. The system of claim 1, wherein the capacitor bank comprises one or more capacitors.

3. The system of claim 1, further comprising:
a) at least one voltage detector coupled to an output of the recharge circuitry to detect an output voltage supplied to the output driver and the capacitor bank;
b) at least one current detector coupled to the output driver to detect an output current supplied by the output driver to the pulsed load;
c) a recharge controller coupled to the recharge circuitry, the at least one voltage detector, and the at least one current detector and configured to control the recharge circuitry based on receipt of the detected output voltage and the detected output current.

4. The system of claim 3, wherein the output current supplied by the output driver to the pulsed load is based on a sum of the leveled input current and a current stored in the capacitor bank as stored energy.

5. The system of claim 3, wherein the output current supplied by the output driver to the pulsed load has a duty cycle of less than 50%, and the recharge circuitry is configured to regulate the build-up of the stored energy in the capacitor bank outside of the duty cycle.

6. The system of claim 5, wherein the leveled input current remains substantially constant both within and outside the duty cycle of the pulsed load.

7. The system of claim 5, wherein the recharge circuitry is configured to receive one or more signals from the recharge controller that is indicative of the duty cycle of the pulsed load.

8. The system of claim 3, further comprising:
a) a bleed circuitry coupled to the capacitor bank to regulate a discharging of the stored energy in the capacitor bank.

9. The system of claim 8, wherein the bleed circuitry is further coupled to the recharge controller to receive one or more bleed current signals to control the bleed circuitry's regulation of the discharging of the stored energy in the capacitor bank.

10. The system of claim 9, wherein the bleed circuitry and the recharge controller are configured to measure a capacitance value of the capacitance bank, and the recharge controller is further configured to regulate the build-up of the stored energy in the capacitor bank based on the measured capacitance value.

11. The system of claim 1, wherein the output driver comprises a transformer coupled to the pulsed load to transfer the energy to the pulsed load.

12. A system for supplying energy to a load, the system comprising:
a) an input circuit configured to receive and condition an input voltage and an input current from a power supply;
b) a transformer circuit coupled to the input module and configured to step up the conditioned input voltage and step down the conditioned input current;
C) an output circuit coupled to the load, the output circuit is configured to store energy received from the transformer and to transfer the energy to the load;
d) an energy detection circuit coupled to the output circuit to monitor a level of the energy at the load; and
e) a recharge circuit configured to receive from the energy detection circuit the monitored level of the energy at the load and configured to transmit an error signal to the input circuit, wherein the input circuit conditions the input voltage and the input current based on the error signal.

13. The system of claim 12, wherein the input circuit comprises a filter circuit to filter the input voltage and the input current.

14. The system of claim 12, wherein the recharge circuit is further configured to receive a predetermined level of energy for the load and compare the predetermined level of energy with the monitored level of the energy at the load to generate the error signal.

15. The system of claim 12, wherein the input circuit comprises a modulator coupled to the recharge circuit and configured to condition the input voltage and the input current based on the error signal.

16. The system of claim 15, wherein the input circuit is configured to condition the input current by maintaining a constant level of the input current when the load is a pulsed load.

17. The system of claim 12, wherein the energy detection circuit comprises a current detection circuit coupled to the load and the output circuit to monitor a current level at the load.

18. The system of claim 17, wherein the energy detection circuit further comprises a voltage detection circuit coupled to the load and the output circuit to monitor a voltage level at the load.

19. The system of claim 12, wherein the output circuit comprises a capacitor bank for storing energy received from the transformer.

20. The system of claim 19, wherein the capacitor bank comprises at least one capacitor.
